(19) United States
(12) Patent Application Publication
(10) Pub. No.: US 2023/0322004 A1
(43) Pub. Date: Oct. 12, 2023

(54) PRINTING APPARATUS

(71) Applicant: CANON KABUSHIKI KAISHA, Tokyo (JP)

(72) Inventors: KOUSUKE TANAKA, Kanagawa (JP); NORIO SAKURAI, Tokyo (JP); ATSUSHI KOHNOTOH, Tokyo (JP); TAKASHI ABE, Kanagawa (JP); YASUYUKI TAKANAKA, Kanagawa (JP); TAIJI MARUYAMA, Kanagawa (JP); YUSUKE NARATANI, Tokyo (JP); SHUHEI YAMAGUCHI, Kanagawa (JP); SHIMPEI FUJISAKI, Tokyo (JP)

(21) Appl. No.: 18/192,714

(22) Filed: Mar. 30, 2023

(30) Foreign Application Priority Data
Apr. 7, 2022 (JP) 2022-064171

(51) Int. Cl. B41J 25/00; B41J 11/00; B41J 25/34

(52) U.S. Cl. CPC B41J 25/001; B41J 11/005; B41J 25/34

(57) ABSTRACT

An embodiment of the present invention is a printing apparatus including: a printing head that includes a nozzle ejecting ink for printing on a printing medium conveyed in a conveyance direction; a carriage on which the printing head is mounted and that reciprocally moves in a main scanning direction; a sliding member attached to the carriage such that the carriage can change a position in a vertical direction; and a guide member that includes a first surface with which the sliding member is brought into contact and a second surface as a back surface of the first surface and guides the movement of the main scanning direction of the carriage, in which the sliding member includes a first regulation unit facing the second surface in a position away from the second surface at a predetermined distance.

### BACKGROUND

### Field

The present disclosure relates to a printing apparatus that prints an image on a printing medium by a printing head mounted on a carriage movable along the printing medium, and specifically relates to a printing apparatus that can switch a distance between the printing head and the printing medium.

### Description of the Related Art

An ink jet printing apparatus has been known as an image formation apparatus such as a printer, a facsimile, and a copier. The ink jet printing apparatus includes a recovery unit that maintains and recovers the ink ejection reliability for forming an image by ejecting ink from a printing head. Additionally, the ink jet printing apparatus includes a guide rail and a slidable sliding member for scanning a carriage on which the printing head is mounted. Moreover, the ink jet printing apparatus includes a switching mechanism that switches a distance between a printing medium and the printing head (so-called a head-to-paper gap) depending on the type of the printing medium.

Japanese Patent Laid-Open No. 2009-61768 discloses a configuration in which a printing apparatus having a configuration of switching a head-to-paper gap between a printing head and a printing medium performs a recovery operation for the printing head with an easy and inexpensive configuration. Specifically, a regulation unit that regulates the movement of a carriage in a vertically upward direction is provided to the carriage. The regulation unit is arranged on a back side of a guide rail and regulates the movement of the carriage with the regulation unit being brought into contact with a back surface of the guide rail once the carriage moves in the vertically upward direction.

### SUMMARY

However, in a case where the printing apparatus has the configuration of switching the head-to-paper gap between the printing head and the printing medium, a clearance between the regulation unit and the guide rail is changed by changing the head-to-paper gap. In a case where a gap between the regulation unit and the back surface of the guide rail is large, and a cap pressure is greater than the weight of the carriage, the carriage is uplifted at the time of the recovery operation, and it is impossible to execute the sufficient recovery operation.

Additionally, there is a risk that the carriage is dropped off from the guide rail in a case where a user raises the carriage to handle jam recovery that occurs during printing or a case where the printing apparatus drops by mistake during distribution, for example.

Therefore, in the light of the above-described problems, an object of the present disclosure is to provide a printing apparatus having a structure that can suppress the carriage uplift and the carriage drop-off.

An embodiment of the present invention is a printing apparatus including: a printing head that includes a nozzle ejecting ink for printing on a printing medium conveyed in a conveyance direction; a carriage on which the printing head is mounted and that reciprocally moves in a main scanning direction; a sliding member attached to the carriage such that the carriage can change a position in a vertical direction; and a guide member that includes a first surface with which the sliding member is brought into contact and a second surface as a back surface of the first surface and guides the movement of the main scanning direction of the carriage, in which the sliding member includes a first regulation unit facing the second surface in a position away from the second surface at a predetermined distance.

Further features of the present invention will become apparent from the following description of exemplary embodiments with reference to the attached drawings.

### BRIEF DESCRIPTION OF THE DRAWINGS

FIG. 1 is a perspective view illustrating a schematic configuration of an ink jet printing apparatus;

FIG. 2 is a perspective view around a carriage;

FIG. 3A is a rear perspective view of a carriage unit, FIG. 3B is a rear perspective view of the carriage, FIG. 3C is a rear perspective view of a sliding member, and FIG. 3D is a rear perspective view of a switching member;

FIG. 4A is a side view around the carriage unit and a guide rail unit, FIG. 4B is a side view of the carriage, FIG. 4C is a side view of the sliding member, and FIG. 4D is a side view of the switching member;

FIG. 5 is an enlarged side view around the switching member;

FIG. 6 is a cross-sectional view of a rear side around the switching member;

FIG. 7 is a cross-sectional view of a front side around the switching member;

FIG. 8 is an enlarged side view around the switching member in a case where a head-to-paper distance is short;

FIG. 9 is a cross-sectional view of the rear side around the switching member in a case where the head-to-paper distance is short;

FIG. 10 is a cross-sectional view of the front side around the switching member in a case where the head-to-paper distance is short;

FIG. 11 is an enlarged side view around the switching member in a case where the head-to-paper distance is long;

FIG. 12 is a cross-sectional view of the rear side around the switching member in a case where the head-to-paper distance is long;

FIG. 13 is a cross-sectional view of the front side around the switching member in a case where the head-to-paper distance is long;

FIG. 14 is a side view around the switching member at the time of capping;

FIGS. 15A to 15E are diagrams illustrating assembling steps of the carriage unit, and FIG. 15F is an enlarged side view around the switching member;

FIG. 16A is a side view around the guide rail and the switching member, and FIG. 16B is an enlarged side view around the guide rail;

FIG. 17 is a side view around the carriage unit and the guide rail unit;

FIG. 18A is a yz plan view illustrating a relationship between the force acting on the carriage unit, and FIGS. 18B to 18D are diagrams describing the relationship between the force acting on the carriage unit;

FIG. 19 is a yz plan view illustrating the relationship between the force acting on the carriage unit at the time of capping;

FIG. 20 is a yz plan view illustrating the relationship between the force acting on the carriage unit at the time of capping; and

FIGS. 21A and 21B are diagrams illustrating a positional relationship between a sliding surface of the guide rail and a first regulation unit.

### DESCRIPTION OF THE EMBODIMENTS

Embodiments are described in detail below with reference to the appended drawings. Note that, the following embodiments are not intended to limit the invention according to the scope of claims. Additionally, although there are described multiple characteristics in the following embodiments, not all the multiple characteristics are necessarily essential to solve the problems, and the multiple characteristics may be used in combination as needed. Moreover, in the appended drawings, the same or similar configurations may be given with the same reference numerals, and duplicated descriptions may be omitted herein.

In the present specification, “printing” indicates a case of forming meaningful information such as characters and graphics. However, it is not limited to this case, and “printing” also indicates a case of widely forming an image, a design, a pattern, and the like on a printing medium or processing the medium regardless of it is meaningful or meaningless and regardless of whether it is visible for a human to perceive with vision.

Additionally, the “printing medium” includes not only printing paper in the form of sheet used in a common image formation apparatus but also roll paper. Also, the “printing medium” includes an arbitrary medium that can be conveyed by a conveyance device included in the printing apparatus such as cloth, a plastic film (OHP), a metallic plate, glass, ceramics, wood, and leather.

Moreover, “ink” can be construed widely as with the definition of “printing” described above. In the present specification, the ink represents a liquid that is applied onto the printing medium and used for formation of an image, a design, a pattern, and the like, processing of the printing medium, or processing of the ink (for example, solidification or insolubilization of color material in the ink applied to the printing medium).

Furthermore, a distance between a platen supporting the printing medium and the printing head is referred to as a “head-to-paper distance”. A distance between the regulation unit and a back surface of a sliding surface of a guide member is referred to as a “clearance distance”.

Additionally, a position of the carriage unit in a vertical direction at the time of performing printing on the printing medium of plain paper is referred to as a “normal position”. The head-to-paper distance in a case of the normal position is referred to as a “normal head-to-paper distance”. Moreover, a position of the carriage unit in the vertical direction in which the printing head is away from the printing medium at the time of performing printing on the printing medium of thick paper such as an envelope is referred to as a “thick paper position”. Furthermore, a position of the carriage unit in the vertical direction in which the printing head is brought close to the printing medium at the time of performing printing on the printing medium of special paper is referred to as a “special paper position”. Note that, the three types of positions as described above are used as an example in the following description; however, the number of types of the positions is not limited to three as long as there are multiple types.

### First Embodiment

<Configuration of Ink Jet Printing Apparatus>

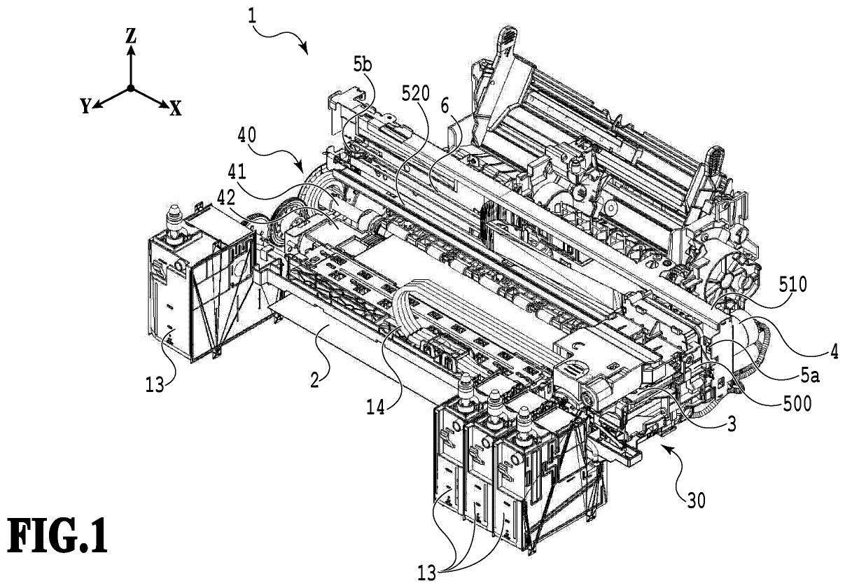

First, a configuration of an ink jet printing apparatus according to the present embodiment is described with reference to FIG. 1. FIG. 1 is a perspective view of an ink jet printing apparatus 1 (hereinafter, written as a printing apparatus 1) according to the present embodiment. The printing apparatus 1 includes a printing head 3 in which a nozzle that ejects ink to a printing medium 2 is formed and an ink tank 13 that stores the ink supplied to the printing head 3. Additionally, the printing apparatus 1 includes a supply tube 14 that forms an ink supply channel for supplying the ink from the ink tank 13 to the printing head 3. A driving belt 6 stretched between a driving pulley 5a and an idler pulley 5b of a motor 4 is locked to a carriage 500, and the carriage 500 reciprocally moves along an X direction by rotation of the driving belt 6. The printing head 3 is detachably mounted on the carriage 500. Note that, a direction in which the carriage 500 reciprocally moves, in other words, a +X direction and a −X direction are collectively referred to as a “main scanning direction”, a “reciprocally moving direction”, or the like.

The printing apparatus 1 includes a conveyance unit 40 that feeds the printing medium 2 in the form of sheet, and the conveyance unit 40 conveys the printing medium 2 in a +Y direction orthogonal to the main scanning direction of the carriage 500 on which the printing head 3 is mounted. Note that, the +Y direction in which the printing medium 2 is conveyed is referred to as a “conveyance direction”. Additionally, a platen 42 is provided below a range in which the printing head 3 moves so as to face the printing head 3. An image is printed with the carriage 500 moving in the main scanning direction and the printing head 3 being driven in synchronization with the movement. Thereafter, a predetermined amount of paper feeding is performed by a conveyance roller 41. The image printing on the entire printing medium 2 is performed by alternately repeating the reciprocal movement of the carriage 500 and the paper feeding as described above.

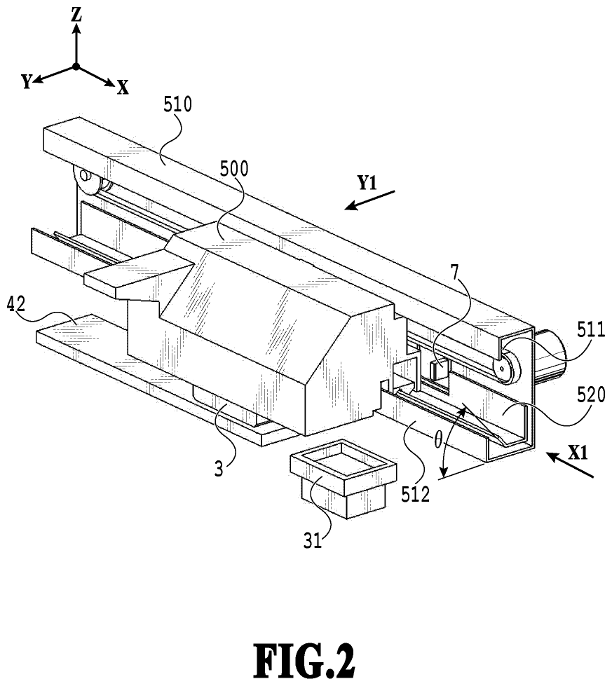

Additionally, the printing apparatus 1 is provided with a recovery unit 30 that prevents clogging of the nozzle in the printing head 3 and also maintains and recovers the printing characteristic of the nozzle, specifically, the ejection performance of the ink. The printing apparatus 1 performs the recovery operation by pressing the printing head 3 by a cap unit 31 (see FIG. 2) from below in the vertical direction (a Z direction).

<Configuration of Carriage Unit>

Next, a configuration of a carriage unit is described with reference to FIGS. 2 to 4C. FIG. 2 is a perspective view illustrating the guide member that allows the carriage 500 to reciprocally move along the main scanning direction, the platen 42, and the cap unit 31.

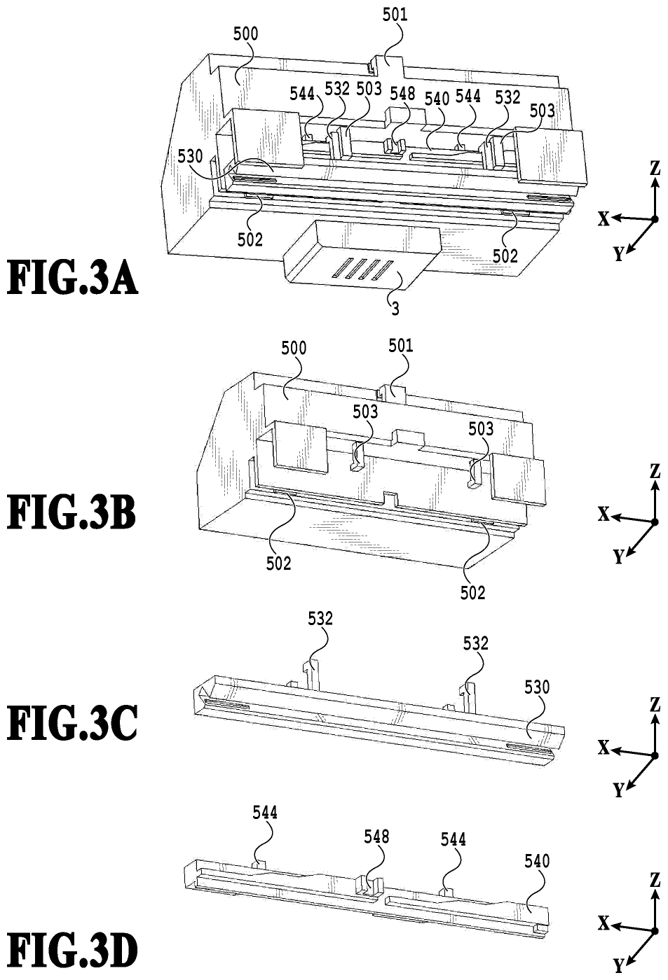

FIG. 3A is a rear perspective view of the carriage unit viewed from an arrow Y1 direction in FIG. 2, FIG. 3B is a rear perspective view of the carriage 500, FIG. 3C is a rear perspective view of a sliding member 530, and FIG. 3D is a rear perspective view of a switching member 540.

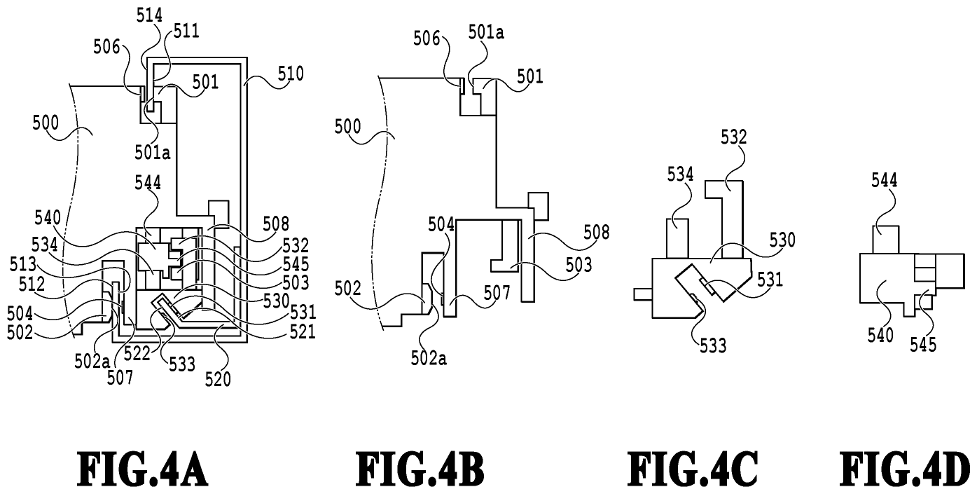

In contrast, FIG. 4A is a side view around the carriage unit and a guide rail unit viewed from an arrow X1 direction in FIG. 2. FIG. 4B is a side view of the carriage 500, FIG. 4C is a side view of the sliding member 530, and FIG. 4D is a side view of the switching member 540.

The carriage 500 includes an upper slider 501 (a third sliding member) and front sliders 502 (second sliding members) (each in different positions in the X direction, two in total). The upper slider 501 (the third sliding member) is brought into contact with a sliding surface 511 (a fifth surface) of a main frame 510. The front sliders 502 (the second sliding members) are brought into contact with a sliding surface 512 (a third surface) of the main frame 510. With the configuration as described above, the position of the printing head 3 with respect to the conveyance direction of the printing medium 2 is determined. A sliding surface of the upper slider 501 (the third sliding member) is 501a, and sliding surfaces of the front sliders 502 (the second sliding members) are 502a. Note that, the upper slider 501 (the third sliding member) and the front sliders 502 (the second sliding members) may not be integral with the carriage 500 and may be separated members attached to the carriage 500.

Additionally, the carriage 500 includes the sliding member 530 and the switching member 540. As illustrated in FIG. 4A or 4C, the sliding member 530 includes a sliding surface 531 that is brought into contact with a sliding surface 521 (a first surface) tilting at an angle θ with respect to a horizontal surface of a guide rail 520 attached to the main frame 510, and this determines a head-to-paper distance. The switching member 540 is provided between the carriage 500 and the sliding member 530 and can change the head-to-paper distance. Two sliding surfaces 531 are formed in positions corresponding to two ends of the carriage.

A switching lever 7 that can advance and retract in the Y direction enters a switching contact portion 548 formed on the switching member 540 and moves the carriage 500 in the X direction; with this, the switching member 540 is slid proportionally to the carriage 500. Thus, it is possible to change the head-to-paper distance.

Because the head-to-paper distance greatly affects the image quality in the printing apparatus 1, the guide rail 520 is formed to be proportionally movable with respect to the main frame 510 in the vertical direction and is formed to be able to adjust the head-to-paper distance.

<Configuration Related to Switching of Head-to-Paper Distance>

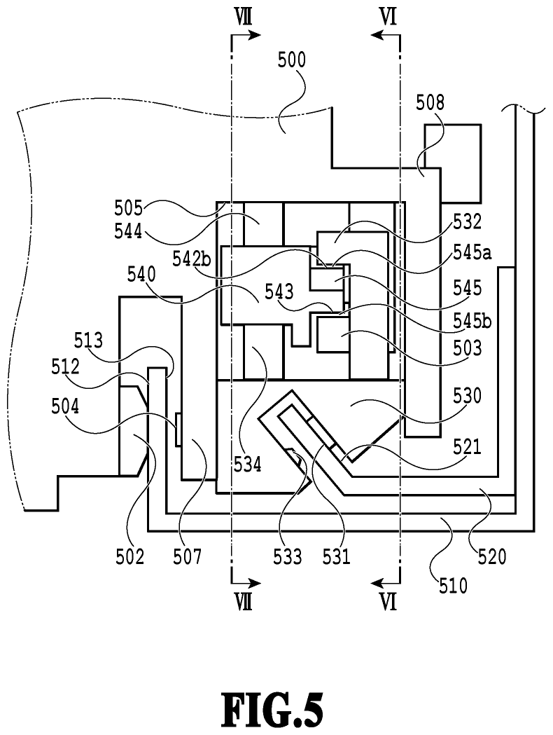

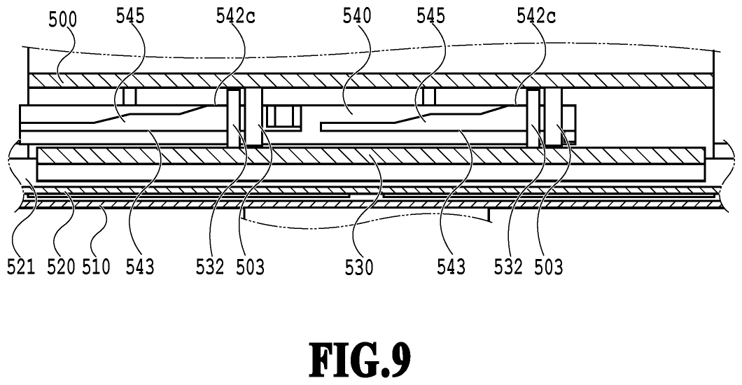

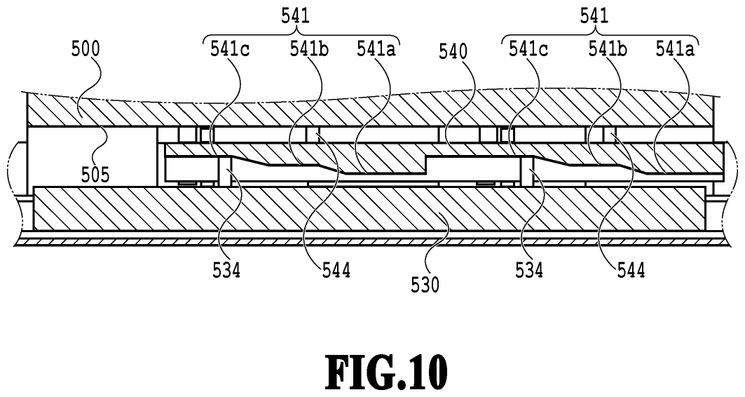

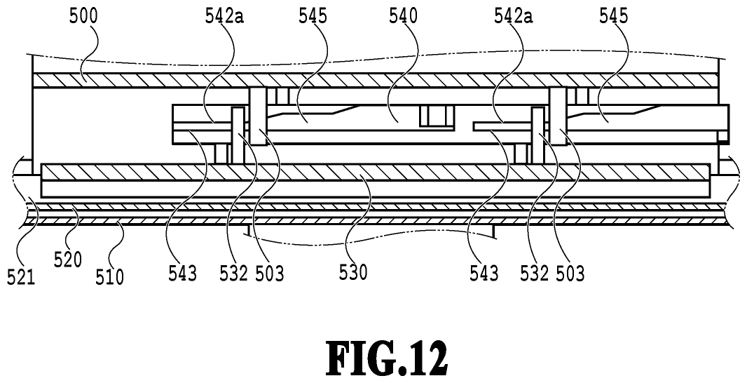

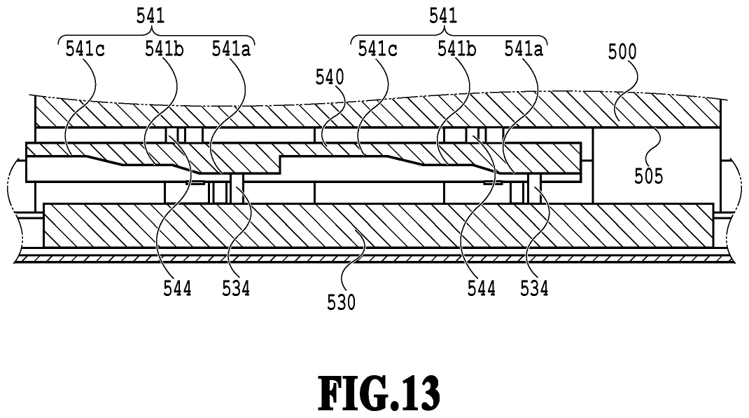

Next, configurations of the sliding member 530 and the switching member 540 for switching the head-to-paper distance are described with reference to FIGS. 5 to 13.

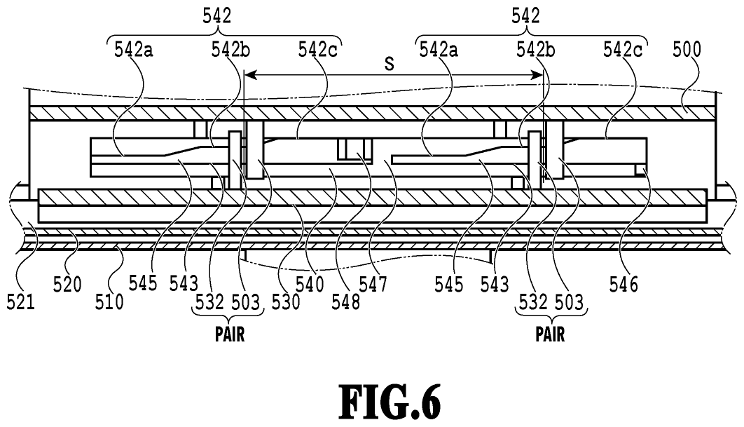

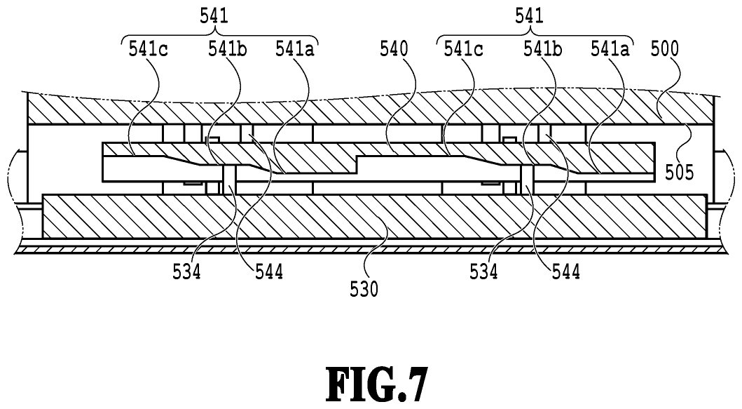

FIG. 5 is an enlarged side view of the carriage 500, the sliding member 530, and the switching member 540 in FIG. 3A. FIG. 6 is a cross-sectional view of a rear side taken along the cross-section line VI-VI in FIG. 5. FIG. 7 is a cross-sectional view of a front side taken along the cross-section line VII-VII in FIG. 5. Note that, a cross-sectional view taken along the cross-section line VI-VI is referred to as a “rear side cross-sectional view”, and the cross-sectional view taken along the cross-section line VII-VII is referred to as a “front side cross-sectional view”.

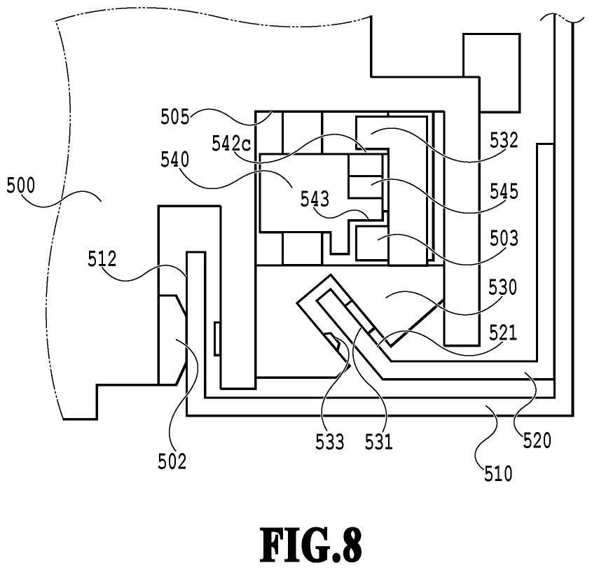

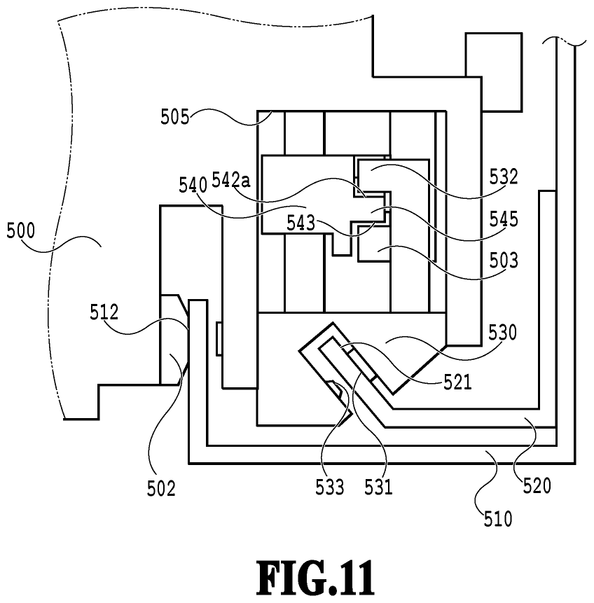

FIGS. 8, 9, and 10 are an enlarged side view, a rear side cross-sectional view, and a front side cross-sectional view, respectively, in a case where the head-to-paper distance is small (short). On the other hand, FIGS. 11, 12, and 13 are an enlarged side view, a rear side cross-sectional view, and a front side cross-sectional view, respectively, in a case where the head-to-paper distance is large (long).

FIGS. 8 to 10 illustrate a state of the special paper position in which the carriage 500 is low in the vertical direction to be close to the guide rail 520. On the other hand, FIGS. 11 to 13 illustrate a state of the thick paper position in which the carriage 500 is high in the vertical direction to be away from the guide rail 520.

The printing medium 2 as a printing target has various types, and the thickness thereof is various as well. For this reason, the printing apparatus 1 of the present embodiment includes the switching member 540 between the carriage 500 and the sliding member 530 to appropriately change the distance between the printing medium 2 and the printing head 3. A reception surface 505 of the carriage 500 is put in contact with a CR supporter 544 of the switching member 540, and the CR supporter 544 supports the carriage 500 at two points. Additionally, a contact portion of the switching member 540 that is put in contact with a switching supporter 534 of the sliding member 530 has a stepwise shape 541 including three flat surface portions that are a high level portion 541a, a middle level portion 541b, and a low level portion 541c. Away in the X direction, there is one more pair of the switching supporter 534 and the three flat surface portions.

The sliding member 530 is mounted proportionally to the carriage so as to be displaceable in the vertical direction and is held by front holders 507 holding a front side that are formed at two ends of the carriage in the X direction and a rear holder 508 holding a rear side.

The position of the switching supporter 534 in the Y direction and the position of the CR supporter 544 in the Y direction are the same so as to suppress rotation of the switching member 540 about an X axis.

In a case where the printing medium 2 is plain paper, the printing operation on the printing medium 2 of plain paper and the recovery operation for the printing head 3 are performed while the carriage 500 is in the normal position in which the switching supporter 534 is put in contact with the middle level portion 541b. On the other hand, in a case of performing printing on photo paper that requires a high image quality (in a case where the printing medium 2 is photo paper), the head-to-paper distance needs to be short to suppress deviated landing of an ink droplet. Accordingly, in this case, the printing operation on the printing medium 2 and the recovery operation for the printing head 3 are performed while the switching supporter 534 is put in contact with the low level portion 541c, in other words, while the carriage 500 is in the special paper position. Additionally, in a case where printing is performed on thick paper or a medium of a material curled easily (in a case where the printing medium 2 is thick paper or the like), the head-to-paper distance needs to be long to prevent rubbing between the printing medium 2 and the printing head 3. Accordingly, in this case, the printing operation on the printing medium 2 and the recovery operation for the printing head 3 are performed while the switching supporter 534 is put in contact with the high level portion 541a, in other words, while the carriage 500 is in the thick paper position.

It is possible to displace the carriage 500 in the vertical direction by sliding and moving the switching member 540 proportionally to the carriage 500 in the main scanning direction as illustrated in FIGS. 7, 10, and 13 and to appropriately change the head-to-paper distance. Assuming that a direction (the Y direction) orthogonal to each of the main scanning direction (the X direction) and the vertical direction (the Z direction) is the conveyance direction, the vertical direction position and the conveyance direction position of the sliding member 530 with respect to the guide rail 520 are not changed even in a case where the head-to-paper distance is changed as illustrated in FIGS. 8 and 11.

Additionally, as illustrated in FIGS. 6, 9, and 12, the sliding member 530 includes a fourth regulation unit 532 that regulates the upward displacement of the switching member 540, and the switching member 540 has a stepwise shape 542. As with the stepwise shape 541, the stepwise shape 542 also includes three flat surface portions that are a high level portion 542a, a middle level portion 542b, and a low level portion 542c. The fourth regulation unit 532 regulates an upper side of each portion of the stepwise shape 542 in the vertical direction. The carriage 500 includes a fifth regulation unit 503, the switching member 540 includes a regulation surface 543, and the upward displacement of the fifth regulation unit 503 in the vertical direction is regulated by the regulation surface 543.

A portion of the switching member 540 that includes the stepwise shape 542 and the regulation surface 543 is referred to as a “pinched portion 545”. As illustrated in FIG. 5, in a case where the printing head 3 is not capped such as during printing, the fourth regulation unit 532 and the pinched portion 545 form an upper clearance 545a, and the fifth regulation unit 503 and the pinched portion 545 form a lower clearance 545b.

As illustrated in FIG. 6, the fifth regulation unit 503 and the fourth regulation unit 532 are in a pair and adjacent to each other in the X direction, and the other pair different from the above pair is arranged at a span S at which it is possible to stabilize the posture of the carriage with the stepwise shape 542. It is desirable that the closer the span S is to the width of the carriage in the X direction.

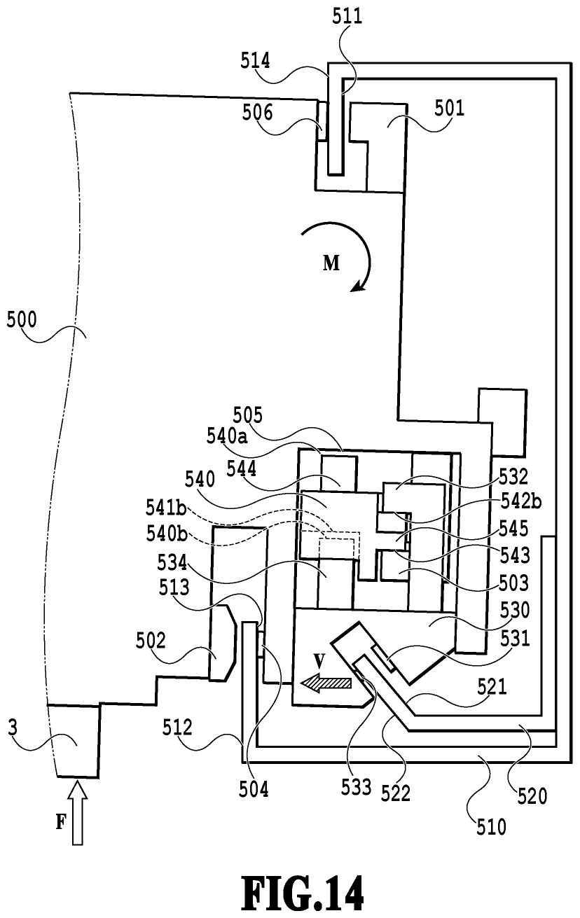

FIG. 14 is an enlarged side view of the carriage 500 in the normal position, the sliding member 530, and the switching member 540 at the time of capping. At the time of capping, the printing head 3 is pressed from below in the vertical direction (force F generated as a pressure at the time of capping acts) by the cap unit 31, the carriage 500 is raised, and the fifth regulation unit 503 of the carriage is brought into contact with the regulation surface 543. The pinched portion 545 is raised by the fifth regulation unit 503, and the switching member 540 is raised and brought into contact with the fourth regulation unit 532. The CR supporter 544 and the reception surface 505 form a clearance 540a, and the switching supporter 534 and the middle level portion 541b form a clearance 540b. The clearance distance of the upper clearance 545a and the clearance distance of the clearance 540b are the same values, and the clearance distance of the lower clearance 545b and the clearance distance of the clearance 540a are the same values (see FIGS. 5 and 14).

Once the sliding member 530 is raised, a first regulation unit 533 is brought into contact with a surface 522 (a second surface) that is a back surface of the sliding surface 521 (the first surface) of the guide rail 520. The pinched portion 545 is pinched between the fifth regulation unit 503 and the fourth regulation unit 532 so as to hold the switching member 540, and thus it is possible to suppress the positional displacement of the switching member 540 with respect to the carriage 500. Once the capping is released, the original contact state and the state with a clearance are obtained again because of the gravity.

The clearance distance of the upper clearance 545a is constant even if the head-to-paper distance is changed, and the clearance distance of the lower clearance 545b is also constant even if the head-to-paper distance is changed. In all the head-to-paper distances, the stepwise shape 542 is regulated by the fourth regulation unit 532, and the fifth regulation unit 503 is regulated by the regulation surface 543; thus, a relationship in which the pinched portion 545 is pinched from top and bottom is obtained. With the relationship as described above, a configuration in which the sliding member 530 and the switching member 540 are not dropped off from the carriage 500 is obtained.

<Assembling Steps>

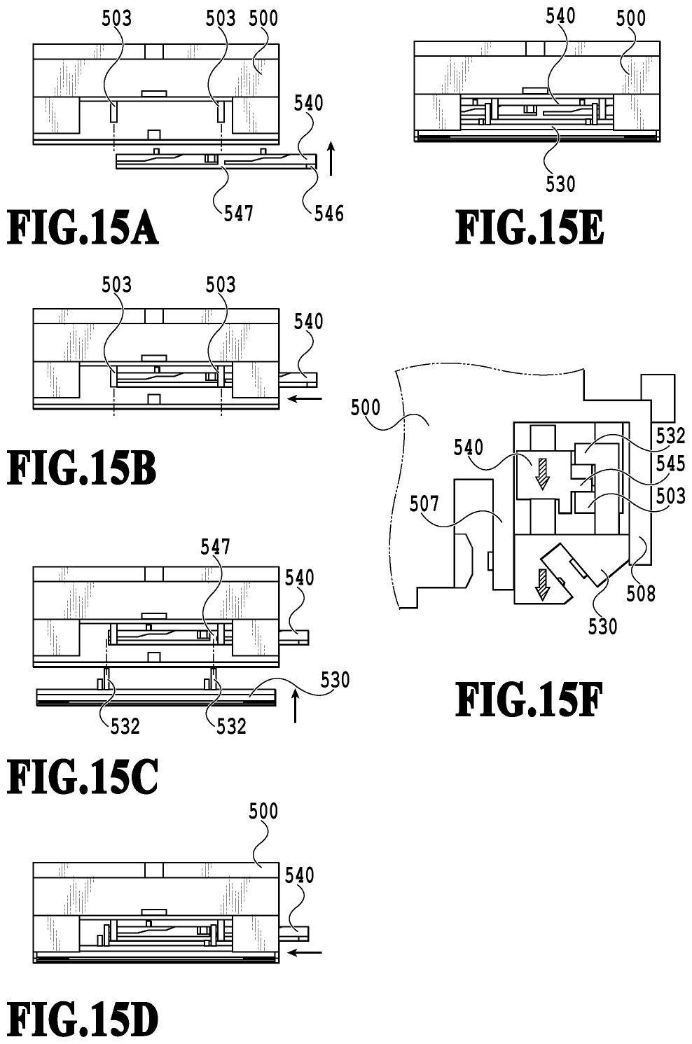

Next, assembling steps of the carriage unit are described with reference to FIGS. 15A to 15F. FIGS. 15A to 15E are diagrams of the steps of assembling the switching member 540 and the sliding member 530 into the carriage 500 viewed from rear side. FIG. 15F is a side view around the switching member 540 in a case where the switching member 540 and the sliding member 530 are assembled into the carriage 500. The steps are described below.

As illustrated in FIG. 15A, the position of the fifth regulation unit 503 of the carriage 500 and the position of an assembling groove 547 of the switching member 540 are aligned, and the switching member 540 is assembled into the carriage 500 from the bottom to the top.

As illustrated in FIG. 15B, the switching member 540 is slightly slid from the right to the left in FIG. 15B.

As illustrated in FIG. 15C, the position of the assembling groove 547 and the position of the fourth regulation unit 532 of the sliding member 530 are aligned, and the sliding member 530 is assembled into the carriage 500 from the bottom to the top.

As illustrated in FIG. 15D, the switching member 540 is slid from the right to the left.

As illustrated in FIG. 15E, the carriage unit is completed. Note that, a stopper 546 (see FIG. 15A) is formed at an end portion of the switching member 540 to be a retainer of the switching member 540.

As illustrated in FIG. 15F, although the gravity acts on the sliding member 530 and the switching member 540 in a case where the carriage 500 is raised, the sliding member 530 and the switching member 540 do not drop since the fifth regulation unit 503 and the fourth regulation unit 532 hold the pinched portion 545. Accordingly, it is possible to prevent the sliding member 530 and the switching member 540 from dropping in a case where the carriage unit is raised to assemble the carriage unit into the main frame and the like.

<Configuration of Regulation Unit>

As described above, it is required to suppress the drop-off of the carriage 500 from the main frame 510 and the guide rail 520 in order to appropriately execute the recovery operation in all the head-to-paper distances or to prepare for a case where a drop impact at the time of distribution is applied.

However, in a case where the regulation unit is provided to a part that changes in the vertical direction with respect to the guide rail 520 along with the change in the head-to-paper distance, the clearance between the regulation unit and the guide rail is changed with the change in the head-to-paper distance. In this case, the clearance between the regulation unit and the guide rail 520 is wider as the head-to-paper distance is shorter, and there is a risk that it is impossible to suppress the drop-off of the carriage.

To deal with this, in the present embodiment, as illustrated in FIG. 5, the first regulation unit 533 provided to the sliding member 530 is provided in a position facing the surface 522 (the second surface) on the back surface of the sliding surface 521 (the first surface) of the guide rail 520 and away from the surface 522 (the second surface) at a predetermined distance. The position of the sliding member 530 is not changed with respect to the vertical direction and the conveyance direction of the guide rail 520 even in a case where the head-to-paper distance is changed, and thus the clearance between the surface 522 (the second surface) and the first regulation unit 533 is not changed all the time. With use of the configuration as described above, it is possible to suppress the carriage drop-off in all the head-to-paper distances.

As illustrated in FIG. 5, in a case where a second regulation unit 504 is provided to the carriage 500, the second regulation unit 504 is provided in a position facing a surface 513 (a fourth surface) on a back surface of the sliding surface 512 (the third surface) of the main frame 510 and away from the surface 513 (the fourth surface) at a predetermined distance. In addition to this, as illustrated in FIG. 4A, a third regulation unit 506 is provided in a position facing a surface 514 (a sixth surface) on a back surface of the sliding surface 511 (the fifth surface) and away from the surface 514 (the sixth surface) at a predetermined distance. With use of the configuration as described above, it is possible to further suppress the carriage drop-off.

At the time of capping, as illustrated in FIG. 14, the carriage 500 may be tilted because the carriage 500, the switching member 540, and the sliding member 530 are integrally raised and slightly rotated in an arrow M direction. As an example, the first regulation unit 533 is brought into contact with the surface 522 (the second surface), the second regulation unit 504 is brought into contact with the surface 513 (the fourth surface), and the third regulation unit 506 is brought into contact with the surface 514 (the sixth surface) in the configuration. FIG. 14 illustrates a case where the three portions of the first regulation unit 533, the second regulation unit 504, and the third regulation unit 506 are brought into contact with the corresponding surfaces; however, this case is not necessarily obtained at the time of tilting of the carriage 500. The regulation unit in one or two portions may be brought into contact with the corresponding surfaces depending on a distance between the regulation units, a clearance amount between each regulation unit and the main frame 510 or the guide rail 520, a friction coefficient between each sliding surface and the main frame 510 or the guide rail 520, a tilt angle of the guide rail 520, and the like.

Additionally, as illustrated in FIG. 14, with the configuration in which the sliding surface 521 (the first surface) is tilted, component force V in the Y direction of the force received from the surface 522 (the second surface) acts on the first regulation unit 533, and the sliding member 530 is pressed in the Y direction. As a result, the timing of the contact with the second regulation unit 504 is brought early, and this causes an effect of stabilizing the posture of the carriage 500.

### Effect of Present Embodiment

According to the present embodiment described above, it is possible to provide a printing apparatus having a structure that can suppress the carriage uplift and the carriage drop-off.

### Second Embodiment

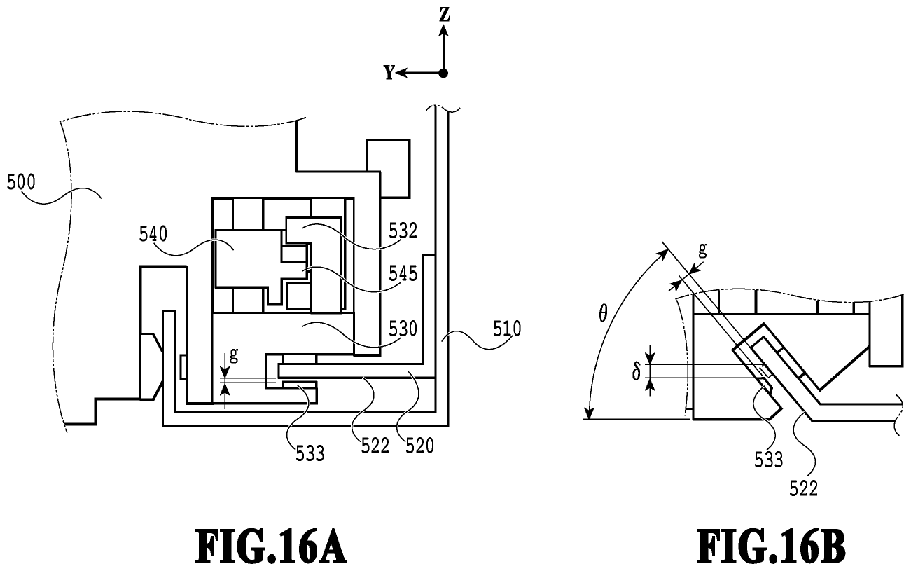

In the above-described first embodiment, the printing apparatus 1 employing the configuration in which the sliding surface 521 (the first surface) and the surface 522 (the second surface) of the guide rail 520 are tilted with respect to a horizontal plane is described as an example. However, as illustrated in FIG. 16A, the technique of the present disclosure is also applicable to the printing apparatus 1 in which the above surfaces of the guide rail 520 are formed of non-tilted horizontal planes.

FIG. 16A illustrates a case where the surface 522 of the guide rail 520 is horizontal. FIG. 16B is an enlarged view around the first regulation unit 533 in a case where the surface 522 of the guide rail 520 is tilted at the angle θ and is a diagram for comparing with FIG. 16A. δ=g/cos (θ), where the length of the clearance between the first regulation unit 533 and the surface 522 (the second surface) is a clearance distance g, and the distance between the first regulation unit 533 and the surface 522 (the second surface) in the vertical direction is a distance δ; therefore, distance δ>clearance distance g is obtained. Accordingly, if the compared configurations have the same clearance distance g, the amount of the uplift of the carriage 500 at the time of capping (the uplift amount) can be smaller in the configuration in which the surface 522 of the guide rail 520 is horizontal than that in the configuration in which the surface 522 is tilted.

### Effect of Present Embodiment

According to the present embodiment described above, it is possible to provide a printing apparatus in which the uplift amount of the carriage is reduced more than the first embodiment.

### Third Embodiment

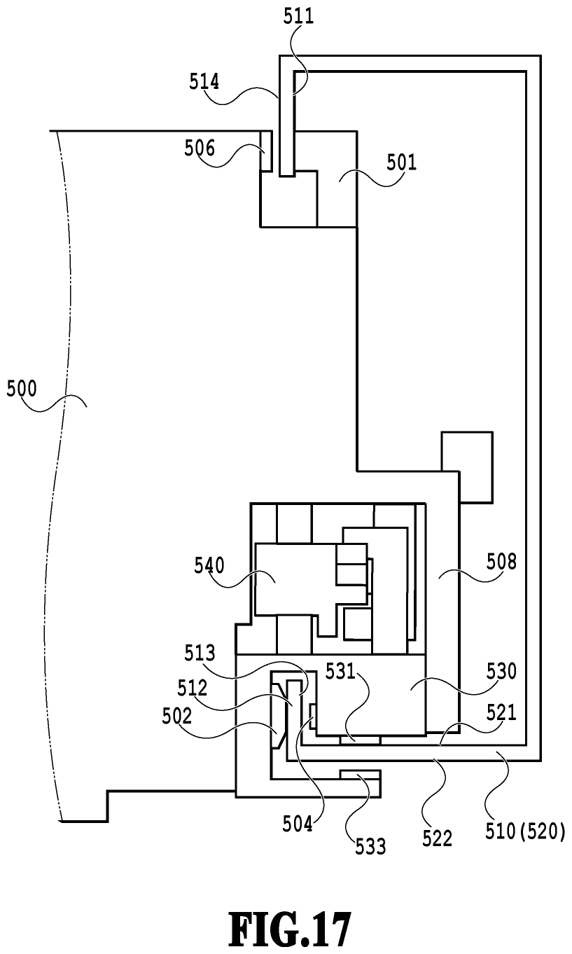

As illustrated in FIG. 17, a configuration including the guide rail 520 (510) in which the guide member and the main frame are implemented integrally is applicable. In this case, the front slider 502 (the second sliding member) and the second regulation unit 504 are formed integral with the sliding member 530.

### Effect of Present Embodiment

According to the present embodiment, it is possible to achieve a reduction in the size and the number of parts of the printing apparatus.

### Fourth Embodiment

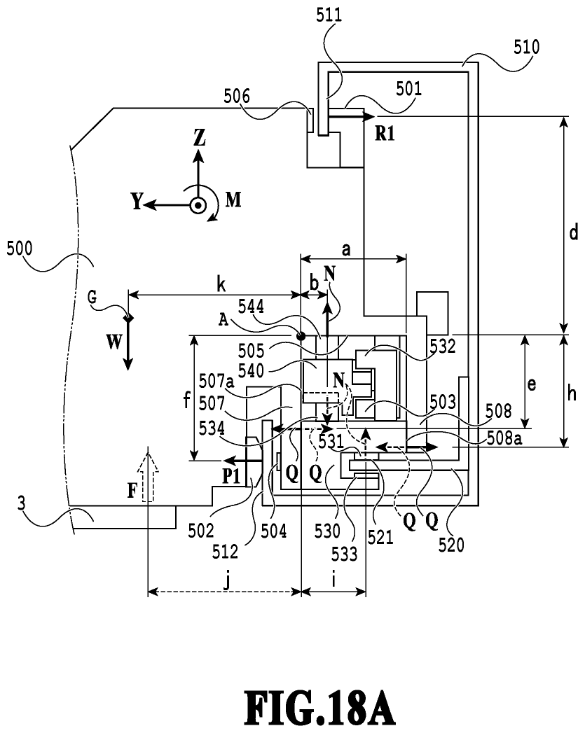

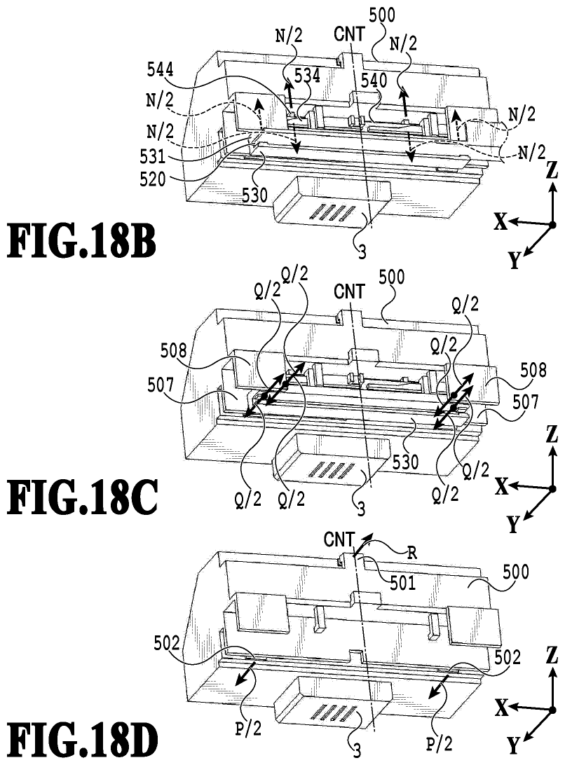

The present embodiment is described with reference to FIGS. 18A to 21B. FIG. 18A is a diagram of a yz plane illustrating a relationship between the force acting on the carriage 500, the switching member 540, the sliding member 530 and the main frame 510, and the guide rail 520 without capping. FIGS. 18B to 18D are diagrams illustrating the relationship between the force viewed from behind the carriage 500. The relationship between the force has a symmetric shape with respect to the center CNT of the carriage 500 for the sake of simplification. Additionally, a half force is applied to each of portions supported by different two portions in the X direction. The half force is indicated by a reference numeral */2 (* is N, Q, or P) in FIGS. 18B to 18D but is indicated as force aggregated to one place in the yz plane (FIG. 18A).

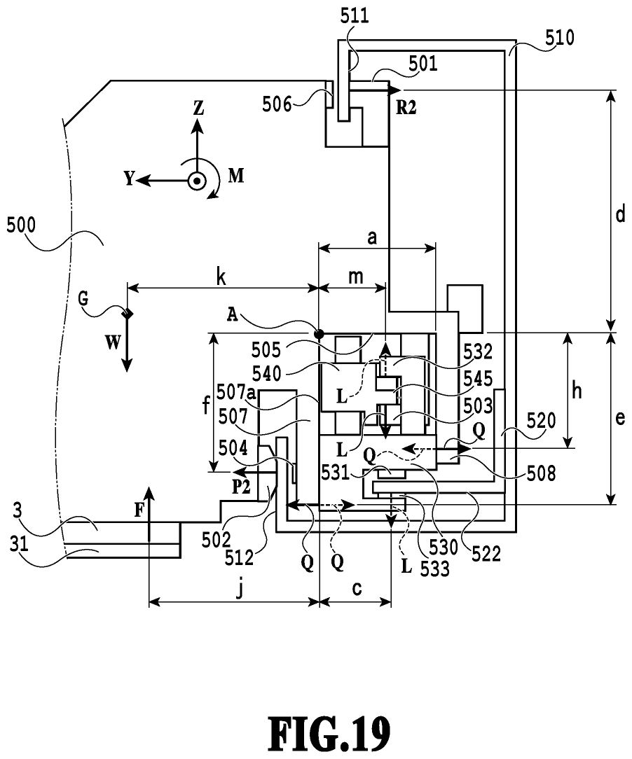

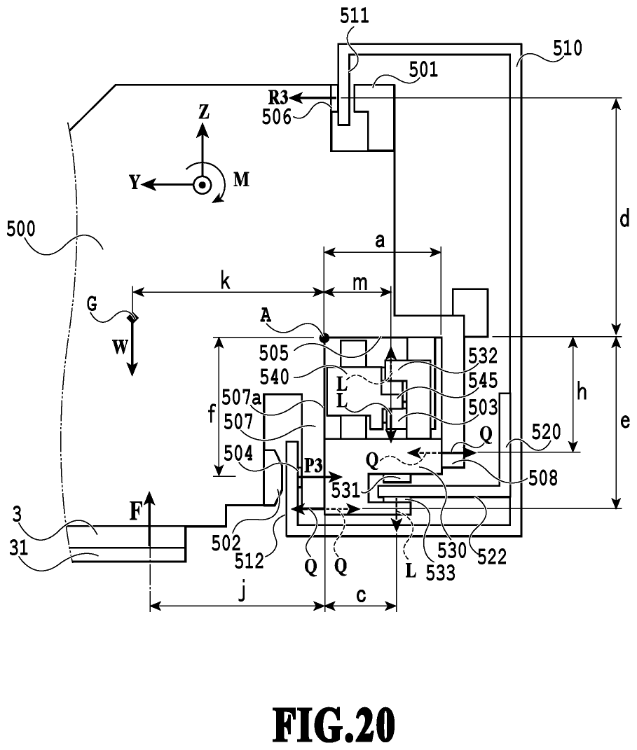

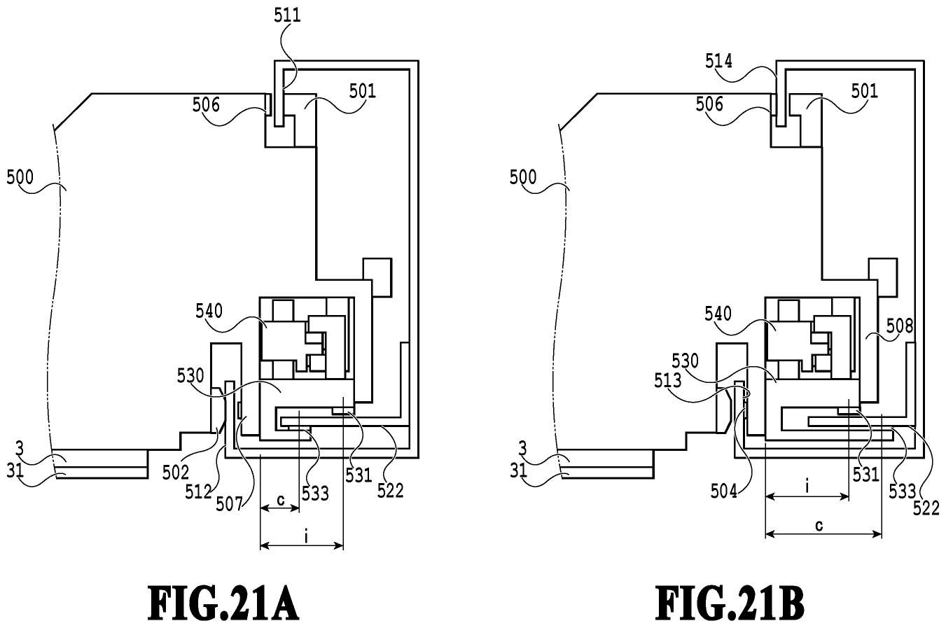

FIG. 19 is a diagram of the yz plane illustrating the relationship between the force acting on the carriage 500, the switching member 540, the sliding member 530 and the main frame 510, and the guide rail 520 in which the first regulation unit 533 is brought into contact at the time of capping. FIG. 20 is a diagram of the yz plane illustrating the relationship between the force acting on the carriage 500, the switching member 540, the sliding member 530 and the main frame 510, and the guide rail 520 in which the first regulation unit 533, the second regulation unit 504, and the third regulation unit 506 are brought into contact at the time of capping. FIG. 21A illustrates a contact state of the sliding member 530 during printing, and FIG. 21B illustrates a contact state of the sliding member 530 during capping.

The following reference numerals and dimensions are used in the above-described drawings.
F: The cap pressure received by the carriage 500 from the cap unit 31 through the printing head 3 (force, solid line arrow).
W: The gravity of the carriage unit including the printing head 3 and the supply tube 14 (force, solid line arrow).
P1: The force received by the carriage 500 from the main frame 510 through the front slider 502 (the second sliding member) at the time of no capping (solid line arrow). At two places at two ends of the carriage 500 in the X direction.
P2: The force received by the carriage 500 from the main frame 510 through the front slider 502 (the second sliding member) at the time of capping (solid line arrow). At the two places at the two ends of the carriage 500 in the X direction.
P3: The force received by the carriage 500 from the main frame 510 through the second regulation unit 504 at the time of capping (solid line arrow). At the two places at the two ends of the carriage 500 in the X direction.
Q: The force received by the front holder 507 or the rear holder 508 of the carriage 500 from the sliding member 530 (solid line arrow) or the force received by the sliding member 530 from the front holder 507 or the rear holder 508 as reaction thereof (broken line arrow). At two places at two ends of the carriage 500 in the X direction.
R1: The force received by the carriage 500 from the main frame 510 through the upper slider 501 (the third sliding member) at the time of no capping (solid line arrow).
R2: The force received by the carriage 500 from the main frame 510 through the upper slider 501 (the third sliding member) at the time of capping (solid line arrow).
R3: The force received by the carriage 500 from the main frame 510 through the third regulation unit 506 at the time of capping (solid line arrow).
N: The force received by the carriage 500 from the switching member 540 (solid line arrow), or the force received by the sliding member 530 from the switching member 540 or the force received by the sliding member 530 from the guide rail 520 (broken line arrow). At two places at two ends of the carriage 500 in the X direction.
L: The force received by the carriage 500 from the switching member 540 (solid line arrow), or the force received by the sliding member 530 from the switching member 540 or the force received by the first regulation unit 533 from the guide rail 520 (broken line arrow). At two places at two ends of the carriage 500 in the X direction.
b: The distance in the Y direction from a boundary 507a on the front side in which the sliding member 530 and the front holder 507 are put in contact with each other to the CR supporter 544.
c: The distance in the Y direction from the boundary 507a to the first regulation unit 533.
d: The distance in the Z direction from the reception surface 505 to the upper slider 501 (the third sliding member).
e: The distance in the Z direction from the reception surface 505 to the force Q acting on the boundary 507a.
f: The distance in the Z direction from the reception surface 505 to the front slider 502 (the second sliding member).
h: The distance in the Z direction from the reception surface 505 to the force Q acting on a boundary 508a.
i: The distance in the Y direction from the boundary 507a to the sliding surface 531 of the sliding member 530.
j: The distance in the Y direction from the boundary 507a to the point of action of the cap pressure.
k: The distance in the Y direction from the boundary 507a to the center of gravity of the carriage.
m: The distance in the Y direction from the boundary 507a to the pinched portion.

In addition to the above, a region between the boundary 507a and the boundary 508a is indicated by a dimension a. Hereinafter, the force P1 is obtained with reference to FIG. 18A under the definitions above.

The equations of equilibrium of the carriage 500 can be represented as P1=R1 in the Y direction and W=N in the Z direction.

The equation of equilibrium of the moment of the carriage 500 can be represented as R1×d+P1×f+Q×e=N×b+W×k+Q×h, where a point A is the center.

The equation of equilibrium of the force of the sliding member 530 is omitted since it is an obvious equation of the reaction.

The equation of equilibrium of the force couple of the sliding member 530 can be represented as Q×(h−e)=N×(i−b).

According to the above, the solution for the force P1 can be represented by using the following Equation (1):

P1=W×(i+k)/(d+f) Equation (1).

Next, the force P2 is obtained with reference to FIG. 19. For the sake of simplification, as with FIG. 18B, the force P2 is symmetric in the X direction, in other words, the force P2 has a symmetric shape with respect to the center CNT of the carriage 500.

The equations of equilibrium of the force of the carriage 500 can be represented as P2=R2 in the Y direction and W+L=F in the Z direction.

The equation of equilibrium of the moment of the carriage 500 can be represented as R2×d+P2×f+Q×e+F×j+L×m=W×k+Q×h, where the point A is the center.

The equation of equilibrium of the force of the sliding member 530 is omitted since it is an obvious equation of the reaction.

The equation of equilibrium of the force couple of the sliding member 530 can be represented as Q×(e−h)=L×(c−m).

According to the above, the solution for the force P2 can be represented by using the following Equation (2):

P2={−(F−W)×c+W×k−F xj}/(d+f) Equation (2).

At last, the force P3 is obtained with reference to FIG. 20. For the sake of simplification, as with FIG. 18B, the force P3 is symmetric in the X direction, in other words, the force P3 has a symmetric shape with respect to the center CNT of the carriage 500.

The equations of equilibrium of the force of the carriage 500 can be represented as P3=R3 in the Y direction and W+L=F in the Z direction.

The equation of equilibrium of the moment of the carriage 500 can be represented as −R3×d−P3×f+Q×e+F×j+L×m=W×k+Q×h, where the point A is the center.

The equation of equilibrium of the force of the sliding member 530 is omitted since it is an obvious equation of the reaction.

The equation of equilibrium of the force couple of the sliding member 530 can be represented as Q×(e−h)=L×(c−m).

According to the above, the solution for the force P3 can be represented by using the following Equation (3):

P3={(F−W)×c−W×k+F×j}/(d+f) Equation (3).

The force P1 needs to be equal to or greater than a predetermined magnitude for the front slider 502 (the second sliding member) to move along the main frame 510 against the oscillation disturbance acting during scanning of the carriage 500 and the tilt of the whole printing apparatus. Additionally, the force P2 is preferably immovable against the load in the Y direction received by the printing head 3 from the cap unit 31 at the time of capping and the tilt of the whole printing apparatus, and the force P2 needs to be equal to or greater than a predetermined magnitude. The force P3 is preferably immovable against the load in the Y direction received by the printing head 3 from the cap unit 31 at the time of capping and the tilt of the whole printing apparatus, and the force P3 needs to be equal to or greater than a predetermined magnitude.

It can be seen that the dimension b that is the distance in the Y direction from the boundary 507a to the CR supporter 544 and the dimension m that is the distance in the Y direction from the boundary 507a to the pinched portion 545 do not affect the force P1, P2, and P3. The above dimensions may be appropriately arranged within a dimension a of the holder of the carriage 500.

Here are focused the dimension i that is the distance in the Y direction from the boundary 507a to the sliding surface 531 and the dimension c that is the distance in the Y direction from the boundary 507a to the first regulation unit 533. According to Equation (1), as the dimension i is greater, the force P1 can be greater. According to Equation (2), as the dimension c is smaller, the force P2 can be greater. According to Equation (3), as the dimension c is greater, the force P3 can be greater. A difference between Equation (2) and Equation (3) is based on a difference between the places with which the regulation unit is brought into contact. In a case where the gravity W of the carriage unit is positioned in the +Y direction in the conveyance direction of the cap pressure F, the front slider 502 (the second sliding member), the upper slider 501 (the third sliding member), and the first regulation unit 533 are brought into contact at the time of capping. In this case, the first regulation unit 533 is put close to the front holder 507 side (FIG. 21A). In a case where the gravity W of the carriage unit is positioned in the −Y direction in the conveyance direction of the cap pressure F, the first regulation unit 533, the second regulation unit 504, and the third regulation unit 506 are brought into contact at the time of capping. In this case, the first regulation unit 533 is put close to the rear holder 508 side (FIG. 21B). Thus, the posture at the time of capping is stabilized.

At last, the idea of the present disclosure is implemented by appropriately combining the contents of the above-described embodiments.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to provide a printing apparatus having a structure that can suppress the carriage uplift and the carriage drop-off.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-064171, filed Apr. 7, 2022, which is hereby incorporated by reference wherein in its entirety.

What is claimed is:

1. A printing apparatus, comprising:
a printing head that includes a nozzle ejecting ink for printing on a printing medium conveyed in a conveyance direction;
a carriage on which the printing head is mounted and that reciprocally moves in a main scanning direction;
a sliding member attached to the carriage such that the carriage can change a position in a vertical direction; and
a guide member that includes a first surface with which the sliding member is brought into contact and a second surface as a back surface of the first surface and guides the movement of the main scanning direction of the carriage, wherein
the sliding member includes a first regulation unit facing the second surface in a position away from the second surface at a predetermined distance.

2. The printing apparatus according to claim 1, further comprising:
a switching member that switches the position of the carriage in the vertical direction, wherein
in a case where the position of the carriage in the vertical direction is switched by the switching member, each of a position in the vertical direction and a position in the conveyance direction of the sliding member is not proportionally changed with respect to the guide member.

3. The printing apparatus according to claim 1, wherein
the sliding member is attached to the carriage so as to be proportionally displaceable in the vertical direction.

4. The printing apparatus according to claim 2, wherein
the switching member switches the position of the carriage in the vertical direction with respect to the guide member.

5. The printing apparatus according to claim 4, wherein
the switching member is mounted so as to be slidable in the main scanning direction between the carriage and the sliding member.

6. The printing apparatus according to claim 2, further comprising:
a second sliding member that is attached to the carriage, wherein
the guide member includes a third surface with which the second sliding member is brought into contact and a fourth surface as a back surface of the third surface, and
the carriage includes a second regulation unit facing the fourth surface in a position away from the fourth surface at a predetermined distance.

7. The printing apparatus according to claim 6, further comprising:
a third sliding member that is attached to the carriage, wherein
the guide member includes a fifth surface with which the third sliding member is brought into contact and a sixth surface as a back surface of the fifth surface, and
the carriage includes a third regulation unit facing the sixth surface in a position away from the sixth surface at a predetermined distance.

8. The printing apparatus according to claim 7, wherein
the sliding member includes a fourth regulation unit that regulates upward displacement of the switching member in the vertical direction, and
the carriage includes a fifth regulation unit that regulates upward displacement in the vertical direction.

9. The printing apparatus according to claim 8, wherein
the switching member includes a pinched portion including a stepwise shape and a regulation surface, and
the pinched portion is held by the fourth regulation unit of the sliding member and the fifth regulation unit of the carriage.

10. The printing apparatus according to claim 9, wherein
there are two pairs of the fourth regulation unit and the fifth regulation unit, and
a length between the two pairs in the main scanning direction is close to a width of the carriage in the main scanning direction.

11. The printing apparatus according to claim 1, further comprising:
a cap unit that performs a recovery operation for the printing head.

12. The printing apparatus according to claim 11, wherein
in a case where the conveyance direction is defined that a side to which the printing medium is conveyed is a front side and a side from which the conveyance is started is a rear side,
if gravity of a carriage unit including the carriage is on the rear side of a cap pressure from the cap unit, the first regulation unit is close to a holder on the front side of the carriage, and
if the gravity is on the front side of the cap pressure, the first regulation unit is close to a holder on the rear side of the carriage.

13. The printing apparatus according to claim 1, wherein
the first surface is tilted with respect to a horizontal plane.

14. The printing apparatus according to claim 2, wherein
a position of a supporter that supports the carriage in the conveyance direction and a position of a supporter that supports the switching member in the conveyance direction are the same.

15. The printing apparatus according to claim 1, wherein
the conveyance direction is orthogonal to each of the main scanning direction and the vertical direction.
